(19) United States
(12) Patent Application Publication
(10) Pub. No.: US 2014/0041489 A1
(43) Pub. Date: Feb. 13, 2014

(54) RATCHET SOCKET TOOL DEVICE

(71) Applicant: Yu Yen CHIEN, Taichung (TW)

(72) Inventor: Yu Yen CHIEN, Taichung (TW)

(21) Appl. No.: 13/572,738

(22) Filed: Aug. 13, 2012

(51) Int. Cl. B25B 13/46

(52) U.S. Cl. 81/62

(57) ABSTRACT

A ratchet socket tool includes a socket member having an internal gear, a driving member rotatably engaged in the socket member, two retaining rings engaged in the socket member, and a pawl engaged in the socket member and having a lever arm extended from a shaft, and one or more teeth formed on the lever arm for engaging with the internal gear, the shaft includes two end segments extended beyond the lever arm for forming two engaging surfaces and for engaging with the retaining rings and for allowing the retaining rings to apply a spring biasing force onto the end segments of the shaft and to force the teeth of the lever arm to engage with the internal gear.

### BACKGROUND OF THE INVENTION

1. Field of the Invention

The present invention relates to a ratchet socket tool device, and more particularly to a ratchet socket tool device including an improved structure having fewer parts or elements to be easily and quickly assembled and manufactured with a decreased manufacturing cost and having an increased driving torque or strength for preventing the ratchet socket tool from being easily and quickly worn out or damaged.

2. Description of the Prior Art

Typical ratchet tools or ratchet wrenches comprise a driving head formed or provided on one end portion of a handle and including a chamber or compartment formed in the driving head for pivotally or rotatably receiving or engaging with a driving shank or member or cartridge, and a pawl movably disposed or attached or mounted or secured or engaged in the driving head for selectively engaging with the gear that is formed and provided on the driving shank or member or cartridge and for determining or controlling the rotating or driving direction of the driving shank or member or cartridge with or by the driving head and the handle and by the users.

For example, U.S. Pat. No. 6,161,454 to Chaconas, U.S. Pat. No. 6,164,166 to Whiteford, U.S. Pat. No. 6,220,123 to Chen, U.S. Pat. No. 6,260,449 to I-He, U.S. Pat. No. 6,282,991 to Hu, U.S. Pat. No. 6,357,323 to Chi et al., U.S. Pat. No. 6,386,072 to Yuan-Chin et al., U.S. Pat. No. 6,435,062 to McCann, U.S. Pat. No. 6,435,063 to Chen, U.S. Pat. No. 6,467,378 to Chen, U.S. Pat. No. 6,959,626 to Shen, and U.S. Pat. No. 7,114,415 to Chiang disclose several of the typical ratchet tools each also comprising a driving head formed or provided on one end portion of a handle and including a chamber or compartment formed in the driving head for pivotally or rotatably receiving or engaging with a driving shank or member or cartridge, and a pawl movably disposed or attached or mounted or secured or engaged in the driving head for selectively engaging with the gear that is formed and provided on the driving shank or member or cartridge and for determining or controlling the rotating or driving direction of the driving shank or member or cartridge with or by the driving head and the handle.

Normally, a controlling or switching device is further required to be provided and engaged into the handle and/or the driving head and coupled or engaged with the pawl for controlling or switching the pawl to engage with the gear at different portions or segments of the gear and thus to determine or control the rotating or driving direction of the driving shank or member or cartridge with or by the driving head and the handle, and thus for allowing various tool shanks, tool extensions, tool elements, fasteners, driven members or the like to be rotated or driven with or by the handle and/or the driving head.

However, the pawl and the controlling or switching device may include a number of parts or elements, and may occupy a great space or volume in the handle and/or the driving head, and the handle and/or the driving head should be drilled or machined or milled with a great space or compartment or chamber or volume that is large enough to receive and engage with the pawl and the controlling or switching device such that the strength and/or the driving torque of the handle and/or the driving head will be greatly decreased.

Typical sockets or socket tools normally comprise a cylindrical or tubular member including a non-circular engaging space or compartment or opening or hole formed therein for receiving or engaging with various tool shanks, tool extensions, tool elements, fasteners, driven members or the like. However, the typical sockets or socket tools have no ratchet mechanisms formed or provided therein such that the typical sockets or socket tools may not be used to suitably engage and drive various tool shanks, tool extensions, tool elements, fasteners, driven members or the like.

The present invention has arisen to mitigate and/or obviate the afore-described disadvantages of the conventional ratchet tools or tools or the like.

### SUMMARY OF THE INVENTION

The primary objective of the present invention is to provide a ratchet socket tool device including an improved structure having fewer parts or elements to be easily and quickly assembled and manufactured with a decreased manufacturing cost.

The other objective of the present invention is to provide a ratchet socket tool device including an increased driving torque or strength for preventing the ratchet socket tool device from being easily and quickly worn out or damaged.

In accordance with one aspect of the invention, there is provided a ratchet tool comprising a socket member including a chamber formed therein, and including an internal gear formed and provided in the socket member, a driving member including a body element rotatably received and engaged in the chamber of the socket member, and including a first outer peripheral groove and a second outer peripheral groove formed in the driving member, and including a recess formed in the driving member and communicating with the first and the second outer peripheral grooves of the driving member, and including a projection extended into the recess of the driving member for forming and defining a compartment and a space in the recess of the driving member, a first retaining ring and a second retaining ring engaged into the first and the second peripheral grooves of the driving member respectively and extended through the recess of the driving member, and a pawl including a shaft received and engaged in the compartment of the recess of the driving member, and including a lever arm extended from the shaft and extended into the space of the recess of the driving member, and including at least one tooth formed and provided on the lever arm for selectively engaging with the internal gear of the socket member and for determining a driving direction of the driving member by the socket member, the shaft including a height greater than that of the lever arm and extended beyond the lever arm for forming and defining a first end segment and a second end segment and for forming and defining two engaging surfaces on the first and the second end segments respectively, and for engaging with the first and the second retaining rings respectively and for allowing the first and the second retaining rings to apply a spring biasing force onto the first and the second end segments of the shaft of the pawl respectively, and for biasing and forcing the tooth of the lever arm to engage with the internal gear of the socket member, and the tooth of the lever arm is forced to engage with the internal gear of the socket member when the socket member are rotated and driven in a driving direction for allowing the driving member to be rotated and driven by the socket member in the driving direction, and the tooth of the lever arm is allowed to be moved away from the internal gear of the socket member and to be selectively received and engaged in the space of the recess of the driving member when the socket member are rotated and driven in an opposite releasing direction, for allowing the socket member to be rotated freely relative to the driving member and the other driven member in the opposite releasing direction.

The compartment of the recess of the driving member is a relatively greater compartment than the space of the recess of the driving member, and the space of the recess of the driving member is a relatively smaller space than the compartment of the recess of the driving member.

The driving member includes a peripheral flap extended laterally and outwardly from the body element for contacting and engaging with the socket member and for limiting or guiding the driving member to move relative to the socket member and for preventing the driving member from being disengaged from the socket member.

The socket member includes a peripheral flange extended radially and inwardly into the chamber of the socket member for forming and defining an inner peripheral shoulder in the socket member, and the driving member includes an outer peripheral shoulder formed therein for engaging with the peripheral flange and the inner peripheral shoulder of the socket member and for anchoring and positioning the driving member to the socket member.

The socket member includes an inner peripheral depression formed therein, and the driving member includes an outer peripheral slot formed therein and aligned with the inner peripheral depression of the socket member for receiving and engaging with a clamping ring and for securing and retaining the driving member to the socket member.

The driving member includes two end cavities formed therein and communicating with each of the outer peripheral grooves of the driving member, and the first and the second retaining rings each include two folded end portions for receiving and engaging with the end cavities of the outer peripheral grooves of the driving member and for anchoring and retaining the first and the second retaining rings to the driving member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a ratchet socket tool device in accordance with the present invention;

FIG. 2 is a perspective view of the ratchet socket tool device;

FIG. 3 is another perspective view similar to FIG. 2, illustrating the operation of the ratchet socket or ratchet tool;

FIG. 4 is a cross sectional view of the ratchet socket or ratchet tool taken along lines 4-4 of FIG. 2;

FIG. 5 is a partial cross sectional view similar to FIG. 4, illustrating the operation of the ratchet socket or ratchet tool;

FIG. 6 is a further perspective view illustrating a portion of the ratchet socket tool device; and

FIG. 7 is a still further perspective view illustrating a driving shank or cartridge or member of the ratchet socket tool device.

### DETAILED DESCRIPTION OF THE PREFERRED EMBODIMENT

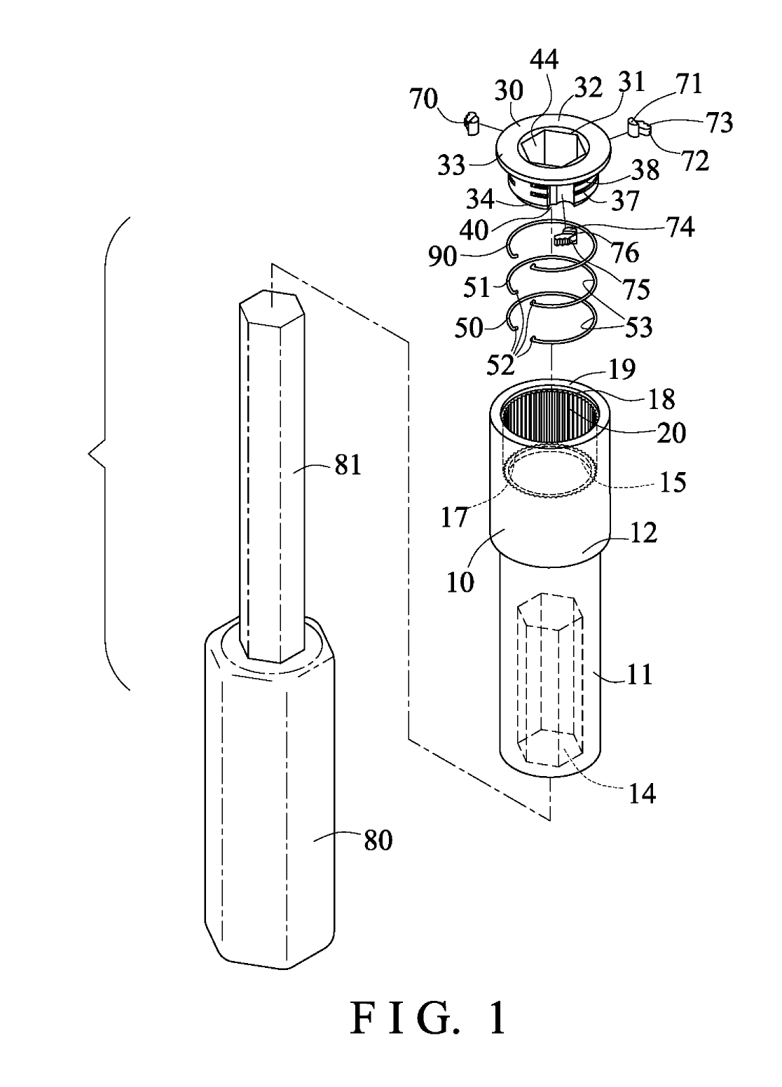

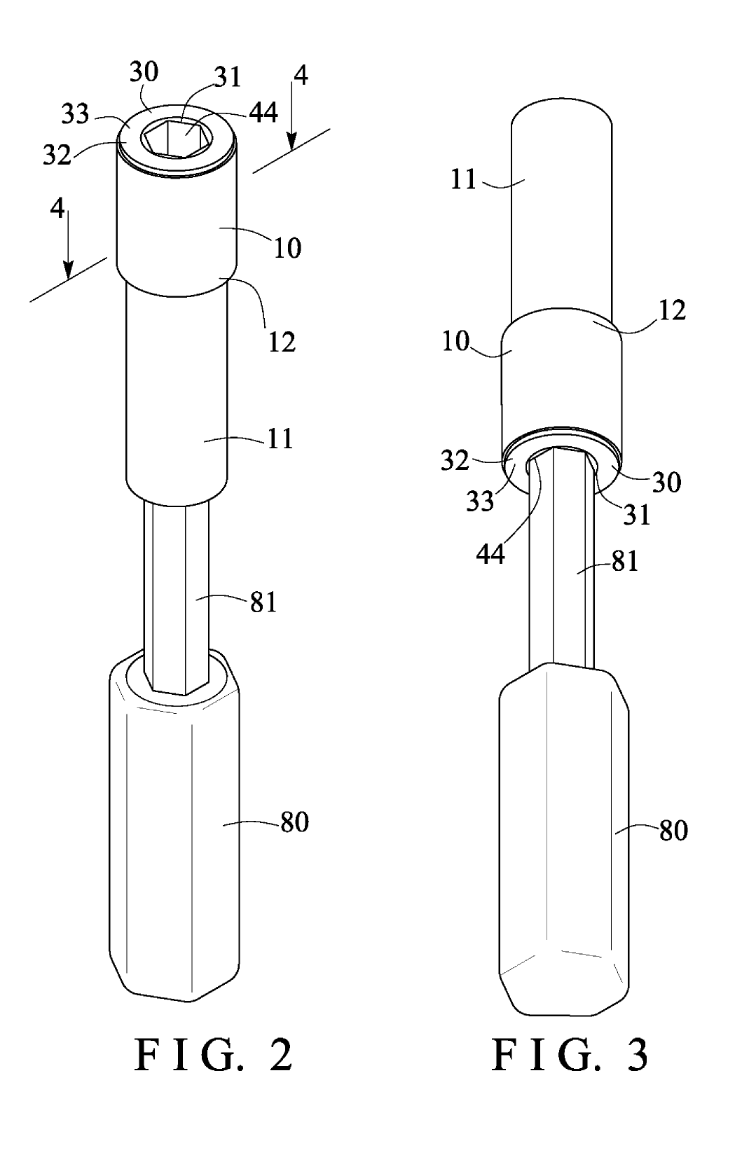

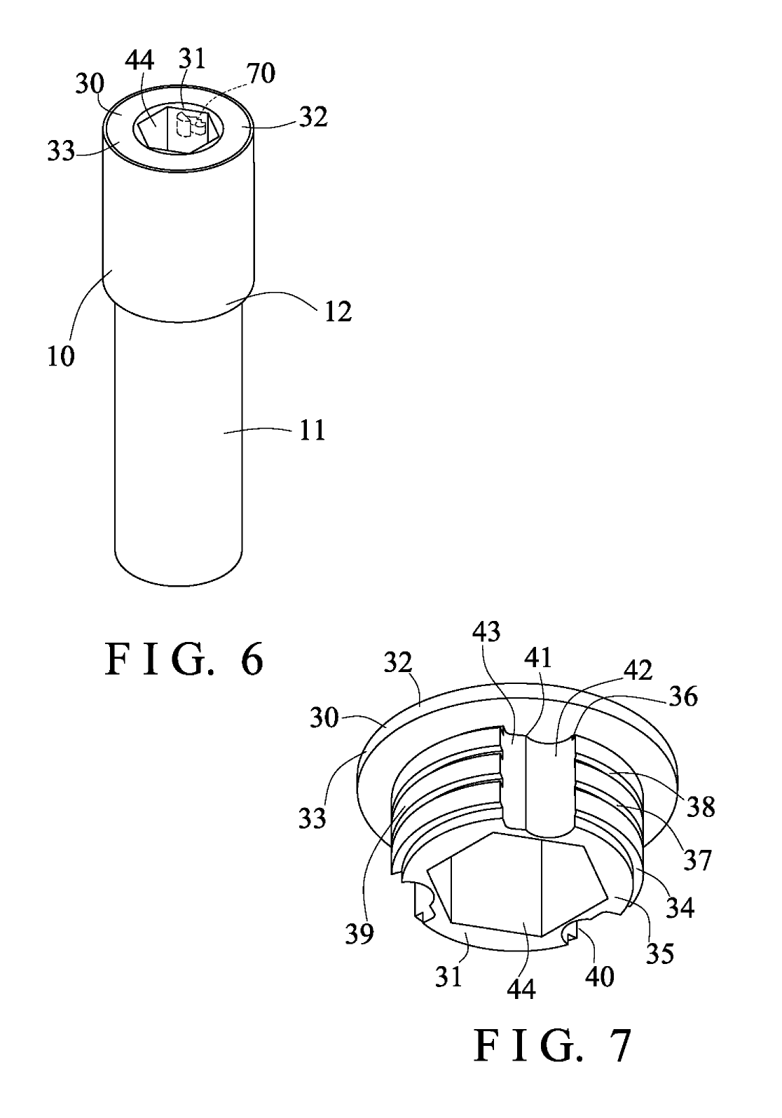

Referring to the drawings, and initially to FIGS. 1-6, a ratchet socket or ratchet tool device in accordance with the present invention comprises a driving device or tubular or cylindrical body or driving head or socket member 10 including a driving stem or shank or handle or extension 11 formed or provided or extended from one end portion 12 of the socket member 10, and including a chamber 13 formed in the one end portion 12 of the socket member 10 for pivotally or rotatably receiving or engaging with a driving shank or cartridge or member 30. The socket member 10 further includes a peripheral rib or flange 15 extended radially and inwardly into the chamber 13 of the socket member 10 for forming or defining an inner peripheral shoulder 17 within the socket member 10, best shown in FIG. 1. The extension 11 of the socket member 10 may include a non-circular engaging space or compartment or hole or opening 14 formed therein for receiving or engaging with various tool extensions, tool elements, fasteners, driven members, tool shanks 81 of tool handles or tool devices 80 (FIGS. 1-2), or the like.

The socket member 10 further includes an inner peripheral channel or groove or recess or depression 18 formed therein, such as formed in the upper portion 19 of the socket member 10, and further includes a gear or gear wheel or internal gear 20 formed and provided on the inner peripheral portion of the socket member 10 and communicating with or extended into the chamber 13 of the socket member 10. The driving shank or cartridge or member 30 includes a tubular or cylindrical body portion or piece or element 31 pivotally or rotatably received or engaged in the chamber 13 of the socket member 10, and includes an outer peripheral flange or rib or flap 32 extended laterally and outwardly from the upper portion 33 of the cylindrical body element 31 for contacting or engaging with the socket member 10 and for limiting the driving member 30 to slide or move relative to the socket member 10 and for preventing the driving member 30 from being disengaged or separated from the socket member 10.

The driving member 30 further includes an outer peripheral channel or groove or recess or shoulder 34 formed therein, such as formed in the lower or bottom portion 35 of the cylindrical body element 31 (FIG. 7) for receiving or engaging with the peripheral flange 15 and/or the inner peripheral shoulder 17 of the socket member 10 and for further solidly and stably securing or anchoring or retaining or positioning the driving member 30 to the socket member 10, and further includes an outer peripheral channel or groove or recess or slot 36 formed therein, such as formed in the upper portion 33 of the cylindrical body element 31 and aligned with the upper inner peripheral depression 18 of the socket member 10 for receiving or engaging with a retaining or clamping ring 90 and for solidly and stably attaching or mounting or securing or latching or locking or anchoring or retaining or positioning the driving member 30 to the socket member 10 and for preventing the driving member 30 from being disengaged or separated from the socket member 10.

The driving member 30 further includes two outer peripheral channels or grooves 37, 38 formed therein, such as a lower or first outer peripheral groove 37 and an upper or middle or intermediate or second outer peripheral groove 38 formed therein, such as formed in the middle or intermediate portion 39 of the cylindrical body element 31 for receiving or engaging with clamping or anchoring or retaining rings 50, 51 therein respectively, and the lower or first retaining ring 50 is disposed or located below the other or upper or middle or intermediate or second retaining ring 51, and the other or upper or middle or intermediate or second retaining ring 51 is disposed or located above the lower or first retaining ring 50 and disposed or located below the clamping ring 90, i.e., the upper or middle or intermediate or second retaining ring 51 is disposed or located between the lower or first retaining ring 50 and the clamping ring 90.

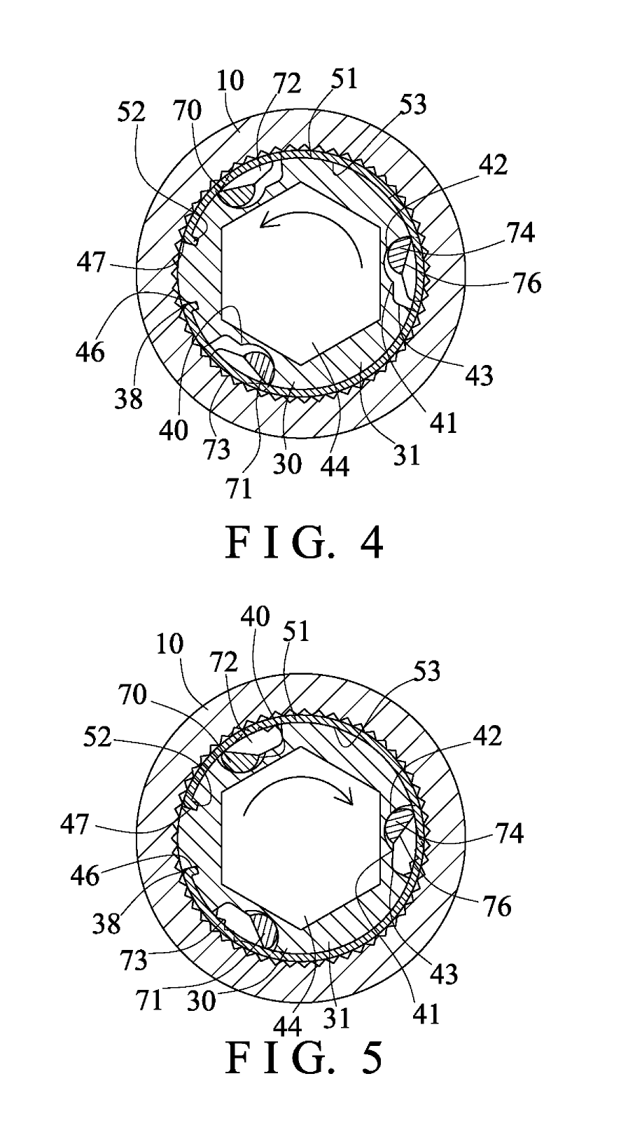

The driving member 30 further includes one or more (such as three) cavities or depressions or recesses 40 formed therein and intersecting or communicating with the outer peripheral grooves 37, 38 and/or the outer peripheral slot 36 of the driving member 30. As best shown in FIGS. 4-5 and 7, the driving member 30 further includes a jut or swelling or protrusion or projection 41 extended into a middle or intermediate portion of each of the recesses 40 of the driving member 30 for forming or defining a relatively greater rounded or curved compartment 42 and a relatively smaller space 43 in each of the recesses 40 of the driving member 30, and further includes a non-circular engaging space or compartment or opening or hole 44 formed in the driving member 30 for receiving or engaging with and for driving various tool extensions, tool elements, fasteners, driven members, tool shanks 81 of tool handles or tool devices 80 or the like, for allowing the socket member 10 and the extension 11 of the ratchet socket tool device to be rotated or driven by the user with the tool shank 81 of tool handle or tool device 80, or for allowing the tool shank 81 of tool handle or tool device 80 to be rotated or driven by the user with the socket member 10 and the extension 11 of the ratchet tool device, or alternatively, the driving member 30 may include a driving shank or stem extended therefrom (not shown) instead of the non-circular engaging space or compartment or opening or hole 44.

The driving member 30 may further include two end cavities 46, 47 formed in and intersecting or communicating with the end portions of the respective outer peripheral grooves 37, 38 and/or the respective outer peripheral slot 36 of the driving member 30 for receiving or engaging with the bent or folded end portions 52 of the respective retaining rings 50-51 and the clamping ring 90 and for solidly and stably attaching or mounting or securing or anchoring or retaining or positioning the retaining rings 50-51 to the driving member 30.

One or more (such as three) pawls 70 are movably or loosely disposed or attached or mounted or secured or engaged into the recesses 40 of the driving member 30 respectively, and each include a curved or rounded shaft 71 having a semi-tubular or cylindrical structure pivotally or rotatably received or engaged in the respective rounded or curved compartment 42 of the recess 40 of the driving member 30, and each include an extension or stem or lever arm 72 laterally extended outwardly from the shaft 71 and extended into the relatively smaller space 43 of the recess 40 of the driving member 30, and each include one or more teeth 73 formed or provided on the lever arm 72 for selectively engaging with the internal gear 20 of the socket member 10 and for determining or controlling the rotating or driving direction of the driving member 30 with or by the socket member 10.

As best shown in FIG. 1, the shaft 71 of the pawl 70 includes a length or height greater than that of the lever arm 72 and extended upwardly and downwardly beyond the lever arm 72 for forming or defining two end portions or segments, such as an upper or first end segment 74 and a lower or bottom or second end segment 75 that are extended upwardly and downwardly or out beyond the lever arm 72 respectively, and for forming or defining two peripheral shoulders or contacting or pressing or engaging surfaces 76 on the end segments 74, 75 respectively, and for selectively engaging with the inner peripheral portions or surfaces 53 of the retaining rings 50-51 (FIGS. 4, 5), and thus for allowing the retaining rings 50-51 to suitably actuate or apply a spring biasing force onto and against the end segments 74, 75 of the shaft 71 of the pawl 70, and for biasing and forcing the teeth 73 of the lever arm 72 to engage with the internal gear 20 that is formed and provided in the socket member 10.

In operation, as shown in FIG. 4, when the socket member 10 is rotated or driven by the user in a driving direction, such as the clockwise direction, the teeth 73 of the lever arm 72 may be forced to solidly and stably engage with the internal gear 20 of the socket member 10 such that the driving member 30 may also be rotated or driven by the socket member 10 in the driving direction, in order to rotate or drive the various tool extensions, tool elements, fasteners, driven members, tool shanks 81 of tool handles or tool devices 80 or the like. On the contrary, as shown in FIG. 5, when the socket member 10 is rotated or driven by the user in the opposite or releasing direction, such as the counterclockwise direction, the teeth 73 of the lever arm 72 may be moved away from the internal gear 20 of the socket member 10 for allowing the socket member 10 to be pivoted or rotated freely relative to the driving member 30 in the opposite or releasing direction.

It is to be noted that the space 43 of the recess 40 of the driving member 30 includes a size or dimension or volume or area greater than that of the lever arm 72 of the pawl 70 for allowing the lever arm 72 of the pawl 70 to be moved rearwardly away from the internal gear 20 of the socket member 10 and to be selectively received or engaged in the compartment 42 and/or the space 43 of the recess 40 of the driving member 30. The retaining rings 50-51 are extended into or through the recesses 40 of the driving member 30 and may be solidly and stably engaged with the engaging surfaces 76 of the end segments 74, 75 of the shaft 71 of the pawl 70 for solidly and stably biasing and forcing the teeth 73 of the lever arm 72 to effectively engage with the internal gear 20 of the socket member 10. In addition, only the recesses 40 are required to be formed in the driving member 30 for receiving or engaging with the pawls 70, and no cavities or recesses are required to be formed in the socket member 10 such that the strength of the socket member 10 will not be decreased or influenced, furthermore, fewer parts or elements are required to be assembled and engaged into the socket member 10 such that the manufacturing cost for the ratchet socket tool may also be reduced or decreased.

Accordingly, the ratchet socket tool device in accordance with the present invention includes an improved structure having fewer parts or elements to be easily and quickly assembled and manufactured with a decreased manufacturing cost and having an increased driving torque or strength for preventing the ratchet socket tool from being easily and quickly worn out or damaged, and the socket member may include an opening and the driving member may include a notch for quickly engaging the tool members into the engaging hole of the driving member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ratchet tool comprising:
a socket member including a chamber formed therein, and including an internal gear formed and provided in said socket member,
a driving member including a body element rotatably received and engaged in said chamber of said socket member, and including a first outer peripheral groove and a second outer peripheral groove formed in said driving member, and including a recess formed in said driving member and communicating with said first and said second outer peripheral grooves of said driving member, and including a projection extended into said recess of said driving member for forming and defining a compartment and a space in said recess of said driving member,
a first retaining ring and a second retaining ring engaged into said first and said second peripheral grooves of said driving member respectively and extended through said recess of said driving member, and
a pawl including a shaft received and engaged in said compartment of said recess of said driving member, and including a lever arm extended from said shaft and extended into said space of said recess of said driving member, and including at least one tooth formed and provided on said lever arm for selectively engaging with said internal gear of said socket member and for determining a driving direction of said driving member by said socket member, said shaft including a height greater than that of said lever arm and extended beyond said lever arm for forming and defining a first end segment and a second end segment and for forming and defining two engaging surfaces on said first and said second end segments respectively, and for engaging with said first and said second retaining rings respectively and for allowing said first and said second retaining rings to apply a spring biasing force onto said first and said second end segments of said shaft of said pawl respectively, and for biasing and forcing said at least one tooth of said lever arm to engage with said internal gear of said socket member, and
said at least one tooth of said lever arm being forced to engage with said internal gear of said socket member when said socket member are rotated and driven in a driving direction for allowing said driving member to be rotated and driven by said socket member in the driving direction, and said at least one tooth of said lever arm being allowed to be moved away from said internal gear of said socket member and to be selectively received and engaged in said space of said recess of said driving member when said socket member are rotated and driven in an opposite releasing direction, for allowing said socket member to be rotated freely relative to said driving member in the opposite releasing direction.

2. The ratchet tool as claimed in claim 1, wherein said compartment of said recess of said driving member is a relatively greater compartment than said space of said recess of said driving member, and said space of said recess of said driving member is a relatively smaller space than said compartment of said recess of said driving member.

3. The ratchet tool as claimed in claim 1, wherein said driving member includes a peripheral flap extended laterally and outwardly from said body element for contacting and engaging with said socket member and for limiting said driving member to move relative to said socket member and for preventing said driving member from being disengaged from said socket member.

4. The ratchet tool as claimed in claim 1, wherein said socket member includes a peripheral flange extended radially and inwardly into said chamber of said socket member for forming and defining an inner peripheral shoulder in said socket member, and said driving member includes an outer peripheral shoulder formed therein for engaging with said peripheral flange and said inner peripheral shoulder of said socket member and for anchoring and positioning said driving member to said socket member.

5. The ratchet tool as claimed in claim 1, wherein said socket member includes an inner peripheral depression formed therein, and said driving member includes an outer peripheral slot formed therein and aligned with said inner peripheral depression of said socket member for receiving and engaging with a clamping ring and for securing and retaining said driving member to said socket member.

6. The ratchet tool as claimed in claim 1, wherein said driving member includes two end cavities formed therein and communicating with each of said outer peripheral grooves of said driving member, and said first and said second retaining rings each include two folded end portions for receiving and engaging with said end cavities of said outer peripheral grooves of said driving member and for anchoring and retaining said first and said second retaining rings to said driving member.
